(19) United States
(12) Patent Application Publication
(10) Pub. No.: US 2026/0005472 A1
(43) Pub. Date: Jan. 1, 2026

(54) EASY-LOCK CONNECTOR FOR A FLAT CONNECTION OBJECT AND METHOD OF ASSEMBLING SUCH AN EASY-LOCK CONNECTOR

(71) Applicant: P-TWO INDUSTRIES INC., Taoyuan City (TW)

(72) Inventors: Chun-Wei Chang, Taoyuan City (TW); Hsien-Chang Lin, Taoyuan City (TW); Chih-Wei Huang, Taoyuan City (TW)

(21) Appl. No.: 19/079,964

(22) Filed: Mar. 14, 2025

(30) Foreign Application Priority Data
Jun. 26, 2024 (TW) 113123756

(51) Int. Cl. H01R 13/629; H01R 12/71; H01R 12/77; H01R 12/79; H01R 13/50

(52) U.S. Cl. CPC H01R 13/62955; H01R 12/716; H01R 12/774; H01R 12/79; H01R 13/50

(57) ABSTRACT

An easy-lock connector for a flat connection object which comprises an insulating housing, a plurality of contacts held by the insulating housing, two locking members and a U-shaped push bar is provided. The locking members are arranged to lock the flat connection object inserted into the easy-lock connector. The U-shaped push bar is operated to bias locking arms of the locking members away from the locking position for releasing the lock on the flat connection object. By means of the U-shaped push bar, the operability of the easy-lock connector is improved, and a low-profile easy-lock connector is realized.

### CROSS-REFERENCES TO RELATED APPLICATIONS

This application claims the benefit of priority to Taiwanese Patent Application No. 113123756 filed on Jun. 26, 2024, which is hereby incorporated by reference in its entirety.

### BACKGROUND OF THE INVENTION

### Field of the Invention

The present invention relates to a connector for a flat connection object such as a flexible flat cable (FFC), a flexible printed circuit (FPC) or the like, and particularly, to a low-profile easy-lock connector for a flat connection object that can be operated with a single hand by a user.

### Descriptions of the Related Art

Taiwanese Utility Model Patent No. M644042U (Patent Document 1) discloses a connector for a flexible flat cable. The connector of Patent Document 1 has an actuator pivoted on an insulating housing, and lock on the flexible flat cable (FFC) is released by pressing a body of the actuator and pivotably operating the actuator. However, this actuator has a certain thickness, making it difficult to achieve a low-profile connector.

U.S. Patent Publication No. 2022/0149565A1 (Patent Document 2) discloses an easy-lock connector with a press-to-unlock structure. In Patent Document 2, the press-to-unlock structure is integrated into the metal shell of the connector. Although the easy-lock connector of Patent Document 2 has a low profile, it is not suitable for one hand operation for releasing lock on the flexible flat cable. On the other hand, when the connector of Patent Document 2 is applied to a small precision narrow-pitch connector, the pressed portion may be made in an area smaller than or equal to 2.2×1.6 mm². The pressed portion has an extremely small size so that it is difficult for the user to accurately position his fingertip directly above the pressed portion. The operation for releasing lock on the flexible flat cable becomes very difficult, and thus it is desired to improve the operability of such an easy-lock connector.

### SUMMARY OF THE INVENTION

One object of the present invention is to provide an easy-lock connector for a flat connection object which has excellent operability and can be operated with one hand for releasing lock on the flat connection object.

Another object of the present invention is to provide an easy-lock connector for a flat connection object having a low profile and suitable for a compact or thin electronic machine.

A further object of the present invention is to provide an easy-lock connector for a flat connection object, wherein the flat connection object can be easily locked by inserting it into the easy-lock connector, thus facilitating automated assembly of the flat connection object and the easy-lock connector.

According to the first aspect of the present invention, an easy-lock connector for a flat connection object is provided, the flat connection object comprising a pair of notches and a plurality of electrode portions, the plurality of electrode portions being formed on an insertion end of the flat connection object, the pair of notches being respectively formed on two opposite lateral edges of the flat connection object and adjacent to the insertion end, the easy-lock connector comprising:
an insulating housing including a fitting opening for insertion of the flat connection object in a first direction;
a plurality of contacts held by the insulating housing and arranged in a second direction perpendicular to the first direction, each contact including a contact portion extending into the fitting opening and being to be in contact with one of the plurality of electrode portions and a connection terminal portion opposite to the contact portion and extending out of the insulating housing;
two locking members, each locking member comprising a locking arm and an actuated portion, the locking arm being normally and elastically biased to a locking position, the locking arm being formed on a distant end with a latch tab so that when the flat connection object is inserted into the fitting opening, the latch tab is engaged with a respective notch of the pair of notches, preventing the flat connection object from being removed from the easy-lock connector; and
a U-shaped push bar, comprising a bar body extending in the second direction and two rocker arms formed on two ends of the bar body respectively and perpendicular to the bar body, the two rocker arms being pivotably arranged on the insulating housing about an axis parallel to the second direction, the bar body being operatively connected with the actuated portion of each locking member, the locking arm being biased away from the locking position by operating the bar body for releasing lock on the flat connection object.

According to the easy-lock connector of the present invention, each locking member comprises a body portion, the locking arm extends from one side of the body portion, the actuated portion is formed on the other side of the body portion, and the body portion is elastically supported in such a way that the locking arm is normally biased to the locking position.

According to the easy-lock connector of the present invention, each locking member comprises a held portion held by the insulating housing and a spring portion, and the held portion and the body portion are connected by the spring portion so that the body portion is elastically supported and floatable with respect to the held portion.

According to the easy-lock connector of the present invention, the insulating housing is formed beneath the locking arm of each locking member with a fulcrum portion, when the actuated portion of each locking member is moved downwardly by pressing the bar body of the U-shaped push bar, the locking arm is pivotably supported by the fulcrum portion so that a distant end of the locking arm is lifted, thereby biasing the locking arm away from the locking position for releasing the lock on the flat connection object.

According to the easy-lock connector of the present invention, the insulating housing is formed beneath the locking arm of each locking member with a horizontal surface and an inclined surface inclined with respect to the horizontal surface, and a boundary line or strip between the horizontal surface and the inclined surface serves as the fulcrum portion.

According to the easy-lock connector of the present invention, the easy-lock connector further comprises a conductive shell attached to the insulating housing and covering at least a portion of the insulating housing, wherein the conductive shell is formed with a first observation window which is positioned to allow an engagement state of the locking arm with one of the notches of the flat connection object inserted into the fitting opening to be visible or inspected visually.

According to the easy-lock connector of the present invention, the conductive shell is formed with a second observation window which is positioned to allow the insertion end of the flat connection object inserted into the fitting opening to be visible or inspected visually.

According to the easy-lock connector of the present invention, the conductive shell is formed with two stopper tabs respectively positioned above the two rocker arms for preventing the two rocker arms from being swung upwardly.

According to the easy-lock connector of the present invention, the insulating housing is formed with two stopper protrusions respectively positioned above the two rocker arms for preventing the two rocker arms from being swung upwardly.

According to the second aspect of the present invention, an easy-lock connector for a flat connection object is provided, the flat connection object comprising a pair of notches and a plurality of electrode portions, the plurality of electrode portions being formed on an insertion end of the flat connection object, the pair of notches being respectively formed on two opposite lateral edges of the flat connection object and adjacent to the insertion end, the easy-lock connector comprising:
an insulating housing including a fitting opening for insertion of the flat connection object in a first direction;
a plurality of contacts held by the insulating housing and arranged in a second direction perpendicular to the first direction, each contact including a contact portion extending into the fitting opening and being to be in contact with one of the plurality of electrode portions and a connection terminal portion opposite to the contact portion and extending out of the insulating housing;
two locking members, each locking member comprising a locking arm and an actuated portion, the locking arm being normally and elastically biased to a locking position, the locking arm being formed on a distant end with a latch tab so that when the flat connection object is inserted into the fitting opening, the latch tab is engaged with a respective notch of the pair of notches, preventing the flat connection object from being removed from the easy-lock connector;
a U-shaped push bar, comprising a bar body extending in the second direction and two rocker arms formed on two ends of the bar body respectively and perpendicular to the bar body, the two rocker arms being pivotably arranged on the insulating housing about an axis parallel to the second direction, the bar body being operatively connected with the actuated portion of each locking member, the locking arm being biased away from the locking position by operating the bar body for releasing lock on the flat connection object; and
a tactile feedback elastic piece, arranged to interfere with the bar body of the U-shaped push bar during a process of pushing the bar body downwardly, so as to generate a resistance force as a function of a position of the bard body or generate a feedback clicking sound or a feedback clicking feel.

According to the easy-lock connector of the present invention, wherein each locking member comprises a body portion, the locking arm extends from one side of the body portion, the actuated portion is formed on the other side of the body portion, and the body portion is elastically supported in such a way that the locking arm is normally biased to the locking position.

According to the easy-lock connector of the present invention, the insulating housing is formed beneath the locking arm of each locking member with a fulcrum portion, when the actuated portion of each locking member is moved downwardly by pressing the bar body of the U-shaped push bar, the locking arm is pivotably supported by the fulcrum portion so that a distant end of the locking arm is lifted, thereby biasing the locking arm away from the locking position for releasing the lock on the flat connection object.

According to the easy-lock connector of the present invention, the tactile feedback elastic piece is configured to be C-shaped.

According to the easy-lock connector of the present invention, the tactile feedback elastic piece comprises a convexly curved section and a straight section positioned under the convexly curved section, the convexly curved section is protruded in the first direction backwardly, the straight section is in parallel to a third direction perpendicular to the first direction and the second direction.

According to the easy-lock connector of the present invention, the easy-lock connector further comprises a conductive shell attached to the insulating housing and covering at least a portion of the insulating housing, wherein the conductive shell is formed with a first observation window which is positioned to allow an engagement state of the locking arm with one of the notches of the flat connection object inserted into the fitting opening to be visible or inspected visually.

According to the easy-lock connector of the present invention, the conductive shell is formed with a second observation window which is positioned to allow the insertion end of the flat connection object inserted into the fitting opening to be visible or inspected visually.

According to the easy-lock connector of the present invention, the conductive shell is formed with two stopper tabs respectively positioned above the two rocker arms for preventing the two rocker arms from being swung upwardly.

According to the third aspect of the present invention, a method for assembling an easy-lock connector for a flat connection object is provided, the flat connection object comprising a pair of notches and a plurality of electrode portions, the plurality of electrode portions being formed on an insertion end of the flat connection object, the pair of notches being respectively formed on two opposite lateral edges of the flat connection object and adjacent to the insertion end, the easy-lock connector comprising:
an insulating housing including a fitting opening for insertion of the flat connection object in a first direction;
a plurality of contacts held by the insulating housing and arranged in a second direction perpendicular to the first direction, each contact including a contact portion extending into the fitting opening and being to be in contact with one of the plurality of electrode portions and a connection terminal portion opposite to the contact portion and extending out of the insulating housing;
two locking members, each locking member comprising a locking arm and an actuated portion, the locking arm being normally and elastically biased to a locking position, the locking arm being formed on a distant end with a latch tab so that when the flat connection object is inserted into the fitting opening, the latch tab is engaged with a respective notch of the pair of notches, preventing the flat connection object from being removed from the easy-lock connector;
a U-shaped push bar, comprising a bar body extending in the second direction and two rocker arms formed on two ends of the bar body respectively and perpendicular to the bar body, the two rocker arms being pivotably arranged on the insulating housing about an axis parallel to the second direction, the bar body being operatively connected with the actuated portion of each locking member, the locking arm being biased away from the locking position by operating the bar body for releasing lock on the flat connection object; and
a conductive shell attached to the insulating housing and covering at least a portion of the insulating housing, the conductive shell comprising a shell body and two lateral wall portions respectively formed on two ends, in the second direction, of the shell body,
wherein the U-shaped push bar includes two pivot portions respectively formed on ends of the two rocker arms opposite to the bar body, and the two pivot portion are in parallel to the second direction, the insulating housing is formed with two first restricting notches for receiving the two pivot portions, the two first restricting notches are opened to a third direction, perpendicular to the first direction and the second direction, upwardly, and the conductive shell is formed with two second restricting notches opened to the first direction backwardly,
the method comprises the steps of:
respectively placing the two pivot portions of the U-shaped push bar into the two first restricting notches of the insulating housing in the third direction; and
attaching the conductive shell to the insulating housing in the first direction so that the two second restricting notches of the conductive shell are respectively fitted to the two pivot portions of the U-shaped push bar.

According to the method of the present invention, the conductive shell is formed with two stopper tabs respectively positioned above the two rocker arms for preventing the two rocker arms from being swung upwardly.

According to the method of the present invention, the two locking members are attached to the insulating housing before the step of respectively placing the two pivot portions of the U-shaped push bar into the two first restricting notches of the insulating housing in the third direction is carried out.

According to the easy-lock connector of the present invention, with aid of provision of the U-shaped push bar which is operatively connected with the locking member, the operability of the easy-lock connector is improved and, on the other hand, the easy-lock connector is allowed to have a low profile. The locking member is configured such that it is biased to an unlocking position when the flat connection object is inserted into the easy-lock connector, thus enabling automated assembly of the flat connection object and the easy-lock connector.

The above and other objects and advantages of the present invention will become apparent from the accompanying drawings and the following detailed description.

### BRIEF DESCRIPTION OF THE DRAWINGS

FIG. 1 is a perspective view of an easy-lock connector according to the first embodiment of the present invention.

FIG. 2 is another perspective view of the easy-lock connector according to the first embodiment of the present invention.

FIG. 3 is an exploded perspective view of the easy-lock connector according to the first embodiment of the present invention.

FIG. 4 is a perspective view of an insulating housing of the easy-lock connector according to the first embodiment of the present invention.

FIG. 5 is a perspective view of a U-shaped push bar of the easy-lock connector according to the first embodiment of the present invention.

FIG. 6 is a perspective view of a locking member of the easy-lock connector according to the first embodiment of the present invention.

FIG. 7 is a perspective view of a conductive shell of the easy-lock connector according to the first embodiment of the present invention.

FIG. 8 is a perspective view of contacts of the easy-lock connector according to the first embodiment of the present invention, in which one of the contacts is shown enlarged.

FIG. 9 is a view schematically illustrating the state that the flat connection objection is inserted into the easy-lock connector.

FIG. 10 is a top view of the easy-lock connector with the flat connection object being inserted thereinto, wherein a first observation window is shown enlarged.

FIG. 11 is a view schematically illustrating the process of releasing the lock on the flat connection object by operating the U-shaped push bar of the easy-lock connector.

FIG. 12 is a view schematically illustrating that the flat connection object is locked by the locking members.

FIG. 13 is a view schematically illustrating that the lock on the flat connection object is released.

FIG. 14 is a perspective view of the easy-lock connector according to the first embodiment of the present invention, wherein the locking members and the conductive shell are not shown.

FIG. 15 is a cross-sectional view of the easy-lock connector according to the first embodiment of the present invention taken along the line AA in FIG. 10.

FIG. 16 is a perspective view of the easy-lock connector according to the second embodiment of the present invention.

FIG. 17 is an exploded perspective view of the easy-lock connector according to the second embodiment of the present invention.

FIG. 18 is a perspective view of a tactile feedback member of the easy-lock connector according to the second embodiment of the present invention.

FIG. 19 is a side view of the tactile feedback member of the easy-lock connector according to the second embodiment of the present invention.

FIG. 20 is a view schematically illustrating a process of unlocking the easy-lock connector according to the second embodiment of the present invention.

FIG. 21 is a top view of the easy-lock connector according to the second embodiment of the present invention.

FIG. 22 is a perspective view of the easy-lock connector according to the third embodiment of the present invention.

FIG. 23 is an exploded perspective view of the easy-lock connector according to the third embodiment of the present invention.

FIG. 24 is a perspective view of a conductive shell of the easy-lock connector according to the third embodiment of the present invention.

FIG. 25 is another perspective view of the conductive shell of the easy-lock connector according to the third embodiment of the present invention.

FIG. 26 is a side view of the conductive shell of the easy-lock connector according to the third embodiment of the present invention.

FIG. 27 is a perspective view of an insulating housing of the easy-lock connector according to the third embodiment of the present invention.

FIG. 28 is a cross-sectional view of the easy-lock connector according to the third embodiment taken along the line BB.

FIG. 29 is a partially enlarged perspective view of the easy-lock connector according to the third embodiment of the present invention.

FIG. 30 is a perspective view of a tactile feedback member of the easy-lock connector according to the third embodiment of the present invention.

FIG. 31 is a side view of the tactile feedback member of the easy-lock connector according to the third embodiment of the present invention.

FIG. 32 is a view schematically illustrating a process of unlocking the easy-lock connector according to the third embodiment of the present invention.

FIG. 33 is a view schematically illustrating a process of assembling the easy-lock connector according to the third embodiment of the present invention.

### DETAILED DESCRIPTION OF THE PREFERRED EMBODIMENT

The easy-lock connector for a flat connection object according to the embodiments of the present invention will be described with reference to the drawings. In the drawings, the same components or components with similar functions are denoted by the same reference numerals. The drawings are not necessarily drawn to scale.

### First Embodiment

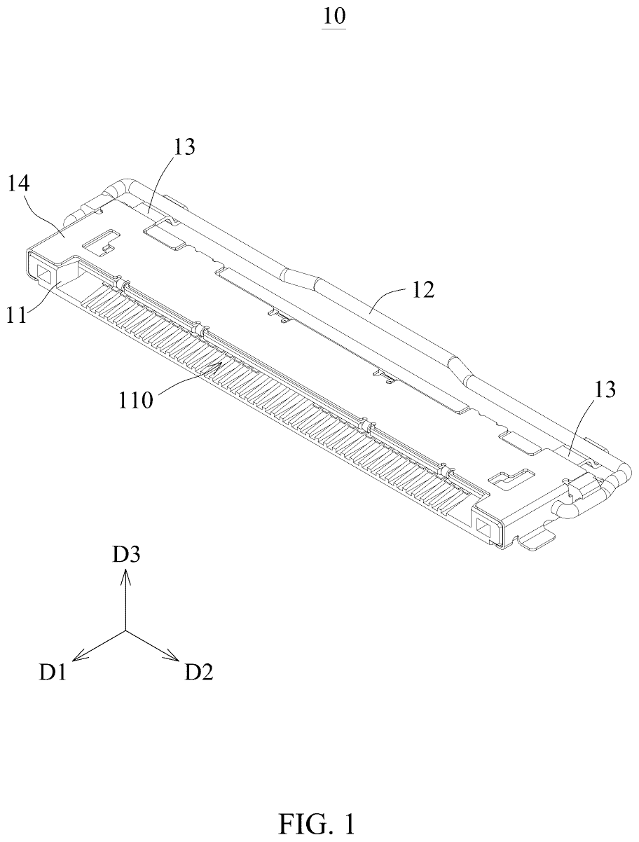

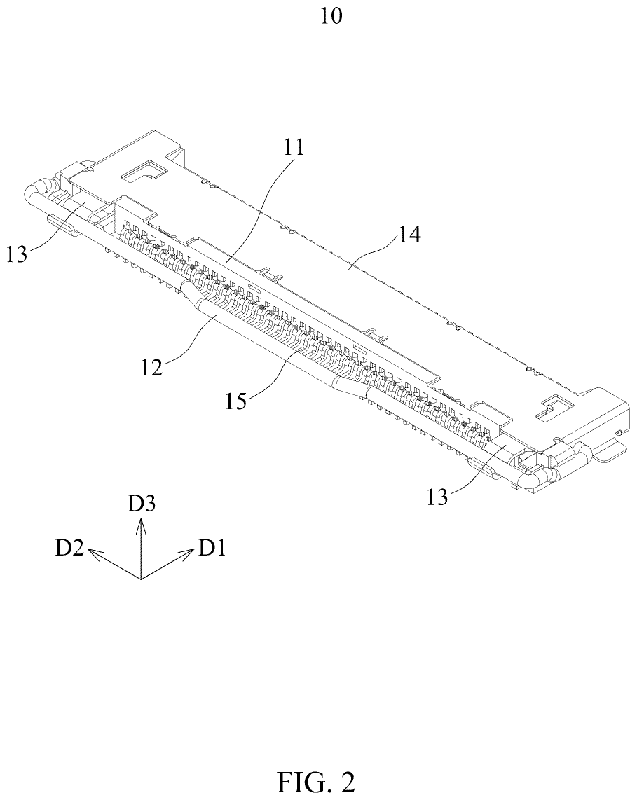

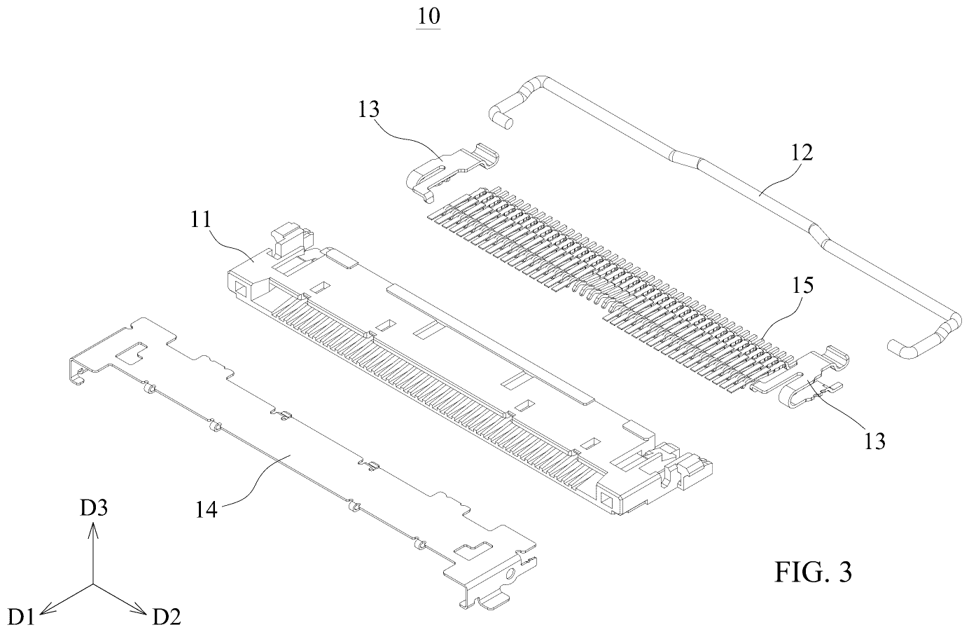

FIG. 1 is a perspective view of the easy-lock connector for a flat connection object according to the first embodiment of the present invention. FIG. 2 is another perspective view of the easy-lock connector for a flat connection object according to the first embodiment of the present invention. FIG. 3 is an exploded perspective view of the easy-lock connector for a flat connection object according to the first embodiment of the present invention. The easy-lock connector for a flat connection object is entirely denoted by the reference numeral 10. The constituent components of the easy-lock connector 10 according to the first embodiment of the present invention is schematically described by referring to FIGS. 1 to 3. The easy-lock connector 10 according to the first embodiment comprises an insulating housing 11, a U-shaped push bar 12, two locking members 13, a conductive shell 14 and a plurality of contacts 15.

The flat connection object is inserted into the easy-lock connector 10 in the first direction D1 (the fitting direction). The flat connection object may be a flexible flat cable (FFC) or a flexible printed circuit (FPC), but is not limited thereto. The flat connection object includes a plurality of electrode portions formed on the insertion end of the flat connection object.

The two locking members 13 are respectively attached to two ends of the insulating housing 11 in the second direction D2 (the width direction) perpendicular to the first direction D1.

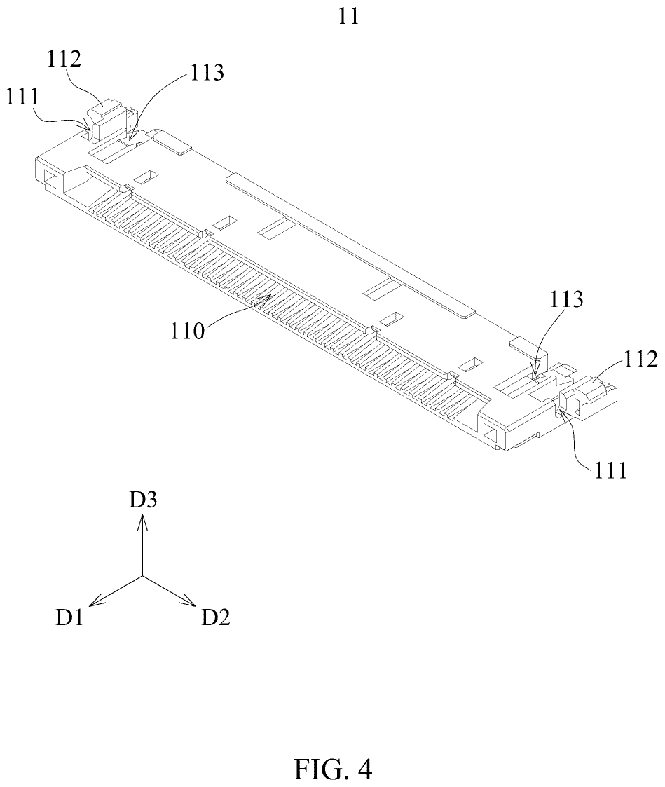

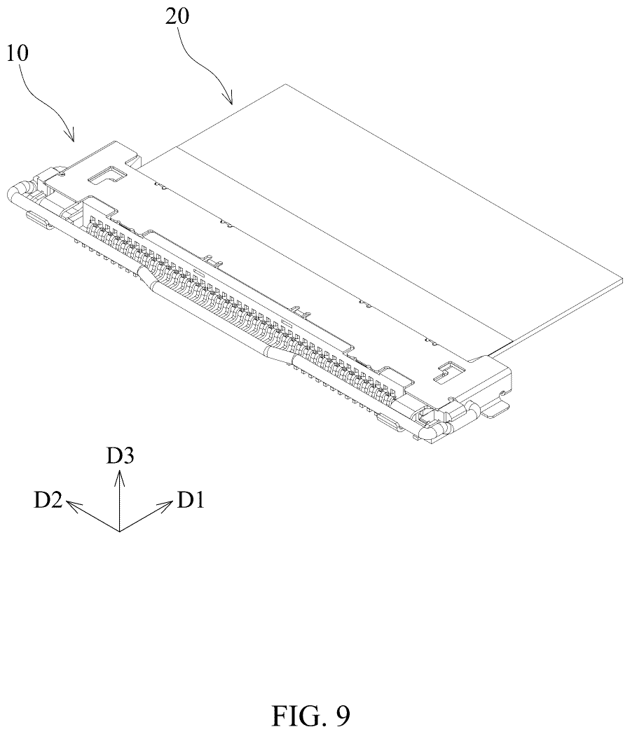

FIG. 4 is a perspective view of the insulating housing 11. The structure of the insulating case 11 is described with reference to FIG. 4. The insulating housing 11 is made of insulating synthetic resin or polymer material. The insulating housing 11 is formed with a fitting opening 110 into which the flat connection object 20 (shown in FIG. 9) can be inserted in the first direction D1. First restricting notches 111 for receiving pivot portions 122 of the U-shaped push bar 12 are formed on two sides of the insulating housing 11 to allow the U-shaped push bar 12 to be arranged on the insulating housing 11 in such a manner that it can swing or rotate with respect to the insulating housing 11. The first restricting notches 111 are opened to the third direction D3 (the height direction) upwardly. The third direction D3 are perpendicular to the first direction D1 and the second direction D2. In order to limit the range where the U-shaped push bar 12 can swing, the insulating housing 11 is formed with a stopper protrusion 112 behind the respective first restricting notch 111.

The insulating housing 11 is formed at two ends with mounting portions 113 for the locking members 13. The locking members 13 are mounted on the mounting portion 113s. Each mounting portion 113 has an opening communicating with the fitting opening 110 and allows a latch tab of the locking member 13 to extend into the fitting opening and allows the engagement state of the flat connection object 20 or a part of the flat connection object 20 to be seen or visually detected through an observation window formed in the conductive shell. In other words, a part of the flat connection object 20 can be exposed through the opening of the mounting portion 113.

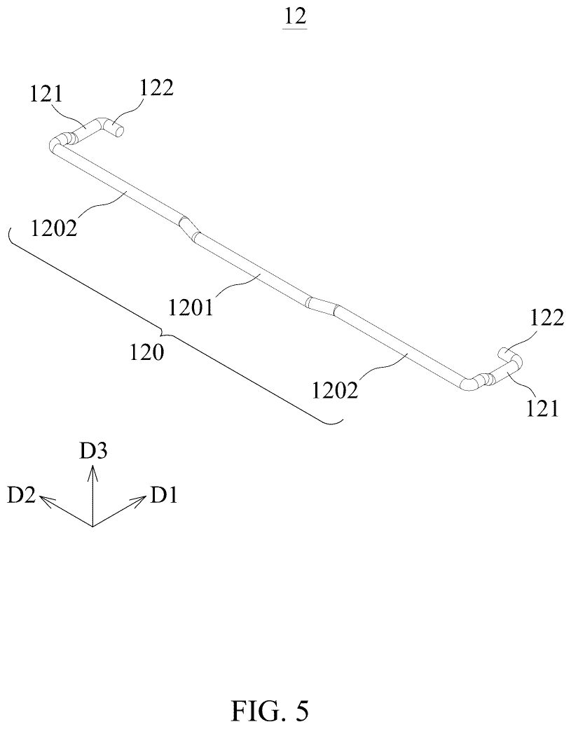

FIG. 5 is a perspective view of the U-shaped push bar. As shown in FIG. 5, the U-shaped push bar 12 has a bar body 120 and two rocker arms 121 respectively formed at two ends of the bar body 120. The bar body 120 extends in the second direction D2 (the width direction). The rocker arms 121 are oriented in the direction perpendicular to the bar body 120. A pivot portion 122 is formed at a distal end of each rocker arm 121. The pivot portion 122 is received in the first restricting notch 111 of the insulating housing 11 so that the rocker arm 121 is rotatably pivoted on the insulating housing 11 about an axis parallel to the second direction D2. In this manner, the U-shaped push bar 12 is pivotably mounted on the insulating housing 11.

The bar body 120 is composed of an operated portion 1201 and two actuating portions 1202. The operated portion 1201 is located between the two actuating portions 1202. The two actuating portions 1202 are operatively connected to the actuated portions (to be described later) of the two locking members 13 respectively. In order to indicate the position of the operated portion 1201 to the user, the bar body 120 is bent so that the operated portion 1201 is not aligned with the two actuating portions 1202. In other words, the operated portion 1201 is offset from the axes of the two actuating portions 1202. If necessary, the operated portion 1201 can be further processed to have a flat profile to increase the contact area with the user's finger.

According to the embodiment of the present invention, the U-shaped push bar 12 is formed by bending a metal bar, but the present invention is not limited thereto. The U-shaped push bar 12 may be formed by stamping a metal plate or by powder metallurgy such as metal injection molding (MIM). The U-shaped push bar 12 may be formed from non-metallic materials such as polymer materials. In order to ensure sufficient strength or rigidity, the U-shaped push bar 12 is preferably made of metal material.

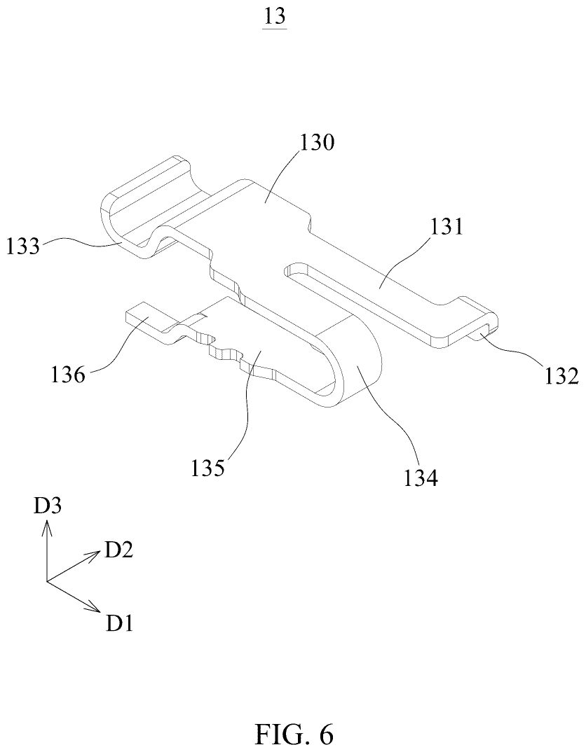

FIG. 6 is a perspective view of the locking member 13. The locking member 13 is formed by punching and bending a metal plate. The locking member 13 includes a body portion 130, a locking arm 131 and an actuated portion 133. The locking arm 131 extends from one side of the body portion 130, and the actuated portion 133 is formed on the other side of the body portion 130. The locking member 13 further includes a U-shaped spring portion 134 and a held portion 135. The held portion 135 is held by the insulating housing 11. The held portion 135 and the body portion 130 are connected by the U-shaped spring portion 134 so that the body portion 130 is elastically supported and capable of floating with respect to the held portion 135. The locking member 13 further includes a soldered portion 136 extending from the held portion 135. The soldered portion 136 can be soldered to a soldering pad formed on a circuit board (not shown) by surface mounting technology (SMT).

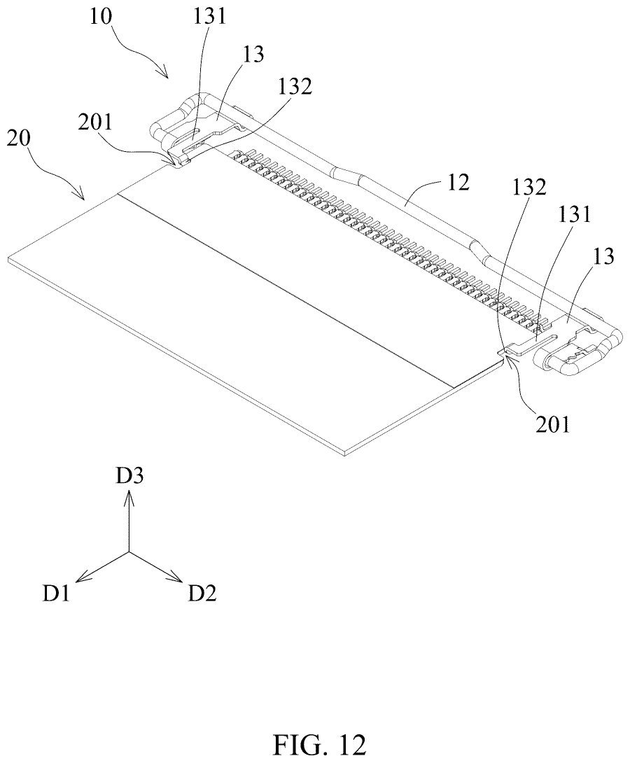

The locking arm 131 is movable between the locking position and the unlocking position. The body portion 130 is elastically supported by the U-shaped spring portion 134 so that the locking arm 131 is normally biased to the locking position. A latch tab 132 is formed at the distal end of the locking arm 131. In the locking position, the latch tab 132 is engaged with the notch (shown in FIG. 12) formed on the lateral edge of the flat connection object 20 inserted into the fitting opening 110 so as to prevent the flat connection object 20 from being pulled out or removed from the easy-lock connector 10.

The actuated portion 133 is operatively connected to the actuating portion 1202 of the U-shaped push bar 12. Specifically, the actuated portion 133 is formed into a hook shape for supporting or receiving the actuating portion 1202 which is bar-shaped, so that the actuated portion 133 is coupled with the actuating portion 1202. Thereby, the actuated portion 133 is linked with the actuating portion 1202. When the operating portion 1201 of the U-shaped push bar 12 is operated or pressed, the actuated portion 133 is urged by the actuating portion 1202 and hence moved together with the actuating portion 1202, thereby biasing the locking arm 131 from the locking position to the unlocking position. In the unlocking position, the latch tab 132 is out of the notch formed on the lateral edge of the flat connection object 20, allowing the flat connection object 20 to be removed from the easy-lock connector 10.

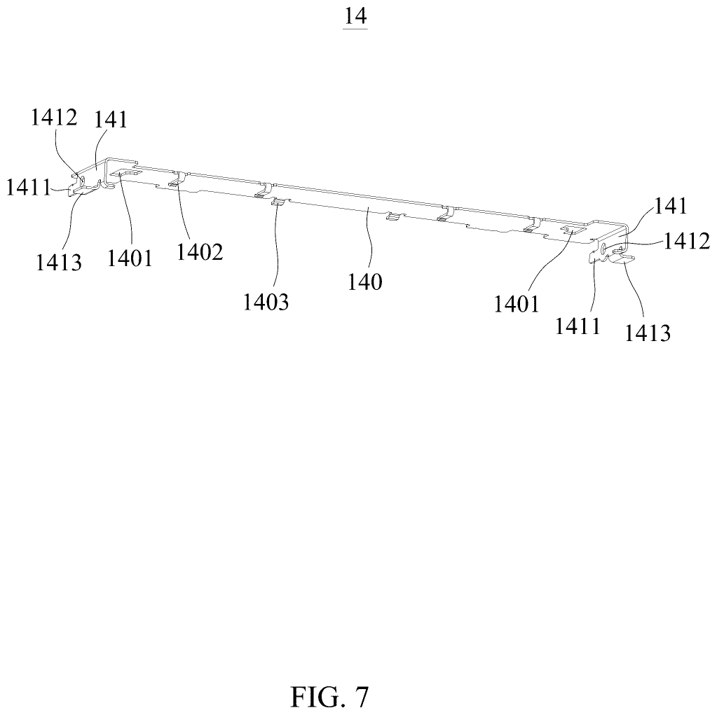

FIG. 7 is a perspective view of the conductive shell. The conductive shell 14 is formed by punching and bending a metal plate. The conductive shell 14 is attached to the insulating housing 11 to cover the upper surface and lateral surfaces of the insulating housing 11. The conductive shell 14 includes a shell body 140 and two lateral wall portions 141 respectively formed at two ends of the shell body 140 in the second direction D2. The shell body 140 is formed with a first observation window 1401 at a position corresponding to the locking arm 131. A plurality of elastic pieces 1402 are formed on the front edge of the shell body 140. These elastic pieces 1402 are bent and extended into the fitting opening 110 so as to contact a conductive metal foil formed on the flat connection object 20 inserted into the easy-lock connector 10. The shell body 140 is formed with a plurality of engaging tabs 1403 on the rear edge. The engaging tabs 1403 are inserted into engaging grooves or engaging holes formed in the insulating housing 11.

The lateral wall portion 141 is formed with a held portion 1411 and an opening 1412. The held portion 1411 is formed with a barb structure. The held portion 1411 is inserted into a holding hole formed in the insulating housing 11 in an interference fit manner. Thereby, the conductive shell 14 is attached on the insulating housing 11. The opening 1412 is formed to allow the pivot portion 122 of the U-shaped push bar 12 to extend therethrough. The lateral wall portion 141 further has a soldered portion 1413. The soldered portion 1413 is positioned in a plane perpendicular to the third direction D3. The soldered portion 1413 can be soldered to the soldering pad of the circuit board (not shown) by surface mounting technology (SMT), thereby mounting the easy-lock connector to the circuit board and connecting the conductive shell 14 to the ground.

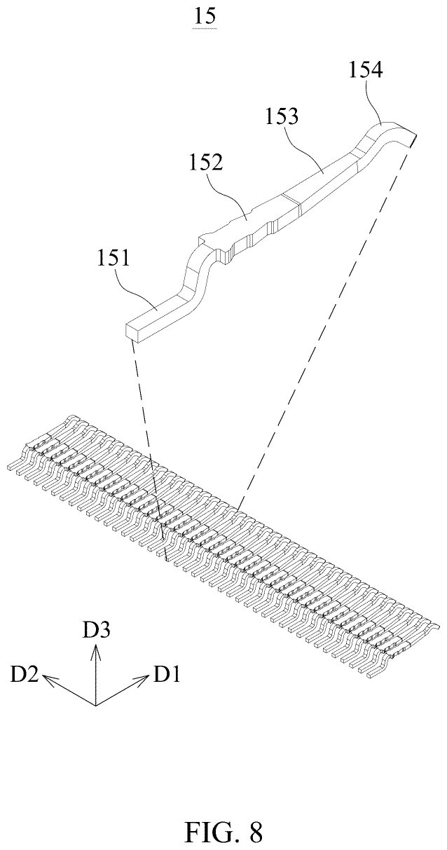

FIG. 8 is a perspective view of a plurality of contacts, wherein one of the contacts is shown enlarged. The contacts 15 are arranged in one row in the second direction D2 and are held by the insulating housing 11. Each contact 15 is made of copper or copper alloy. As shown in FIG. 8, the contact 15 has a connection terminal portion 151, a held portion 152, a contact arm 153 and a contact portion 154. The contact arm 153 extends from one end of the held portion 152, and the connection terminal portion 151 extends from the other end of the held portion 152. The held portion 152 is formed with a barb structure. The held portion 152 is inserted into a holding groove or a holding hole formed in the insulating housing 11 in an interference fit manner. The contact portion 154 is formed at the distal end of the contact arm 153. The contact arm 153 extends into the fitting opening 110 of the insulating housing 11 so that the contact portion 154 is capable of being in contact with the electrode portion formed on the flat connection object. The connection terminal portion 151 extends out of the insulating housing 11. The connection terminal portion 151 can be soldered to a soldering pad formed on the circuit board by surface mounting technology (SMT).

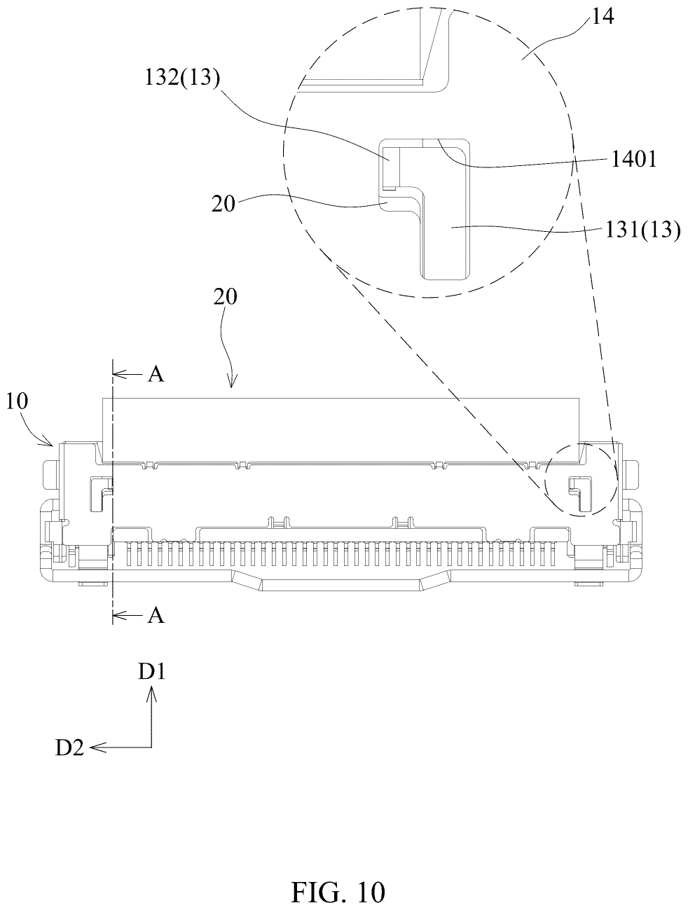

FIG. 9 is a view schematically showing a state in which the flat connection object is inserted into the easy-lock connector. FIG. 10 is a top view of the easy-lock connector into which the flat connection object is inserted. In FIG. 10, the first observation window 1401 of the conductive housing 14 is shown enlarged. The first observation window 1401 is formed substantially at a position corresponding to the locking arm 131 of the locking member 13. The engagement state between the locking arm 131 of the locking member 13 and the flat connection object can be seen or visually detected through the first observation window 1401. For example, the engagement state between the locking member and the flat connection object can be inspected by automated optical inspection (AOI). If it is observed from the first observation window 1401 that the latch tab 132 of the locking member 13 is located in the notch of the flat connection object, it is determined that the locking member is engaged with the flat connection object (that is, the flat connection object is locked).

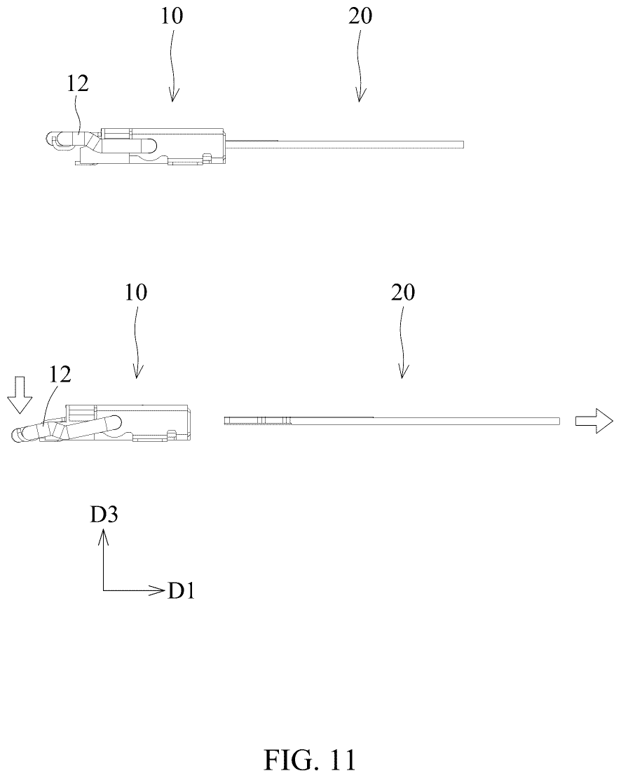

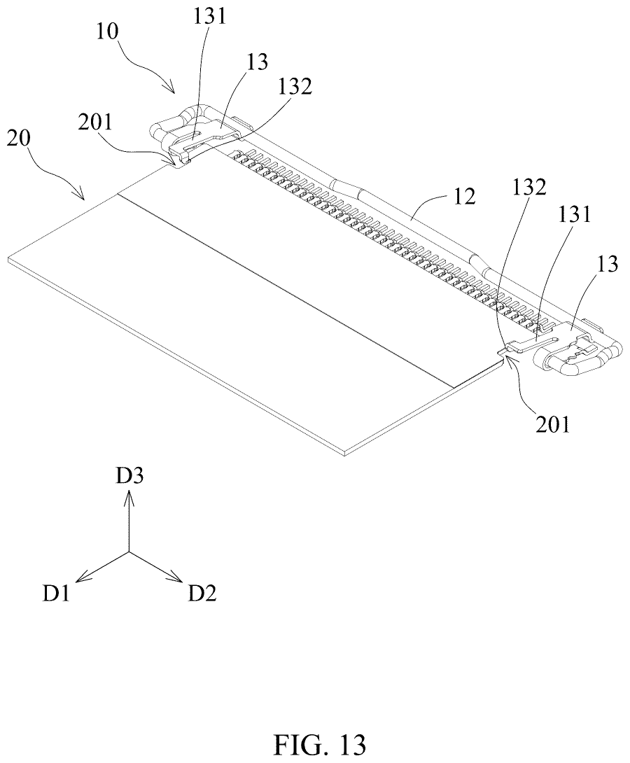

FIG. 11 is a view schematically showing a process of releasing the lock on the flat connection object by operating the U-shaped push bar of the easy-lock connector. FIG. 12 is a view schematically showing that the flat connection object is locked by the locking members. FIG. 13 is a view schematically showing that the lock on the flat connection object is released. The lock on the flat connection object and release of the lock is described with reference to FIGS. 11 to 13. In order to clearly show the connection relationship between the locking arms 131 and the flat connection object, the insulating housing 11 and the conductive shell 14 are not shown in FIGS. 12 and 13.

As shown in FIG. 11, by pressing the U-shaped push bar 12 in the third direction D3 (the height direction) perpendicular to the first direction D1 and the second direction D2, the lock on the flat connection object 20 is released, allowing the flat connection object 20 to be removed in the first direction D1 from the easy-lock connector 10.

As shown in FIG. 12, the flat connection object 20 has a pair of notches 201 respectively formed on two opposite lateral edges of the flat connection object 20 and adjacent to the insertion end. In FIG. 12, the locking arm 131 of each locking member 13 is in the locking position, and the latch tab 132 formed at the distal end of the locking arm 131 is engaged with the respective notch 201 so as to prevent the flat connection object 20 from being removed.

In FIG. 13, by operating the U-shaped push bar 12, the locking arm 131 of each locking member 13 is biased from the locking position to the unlocking position. At that time, the latch tab 132 is disengaged from the notch 201, thereby releasing the lock on the flat connection object 20.

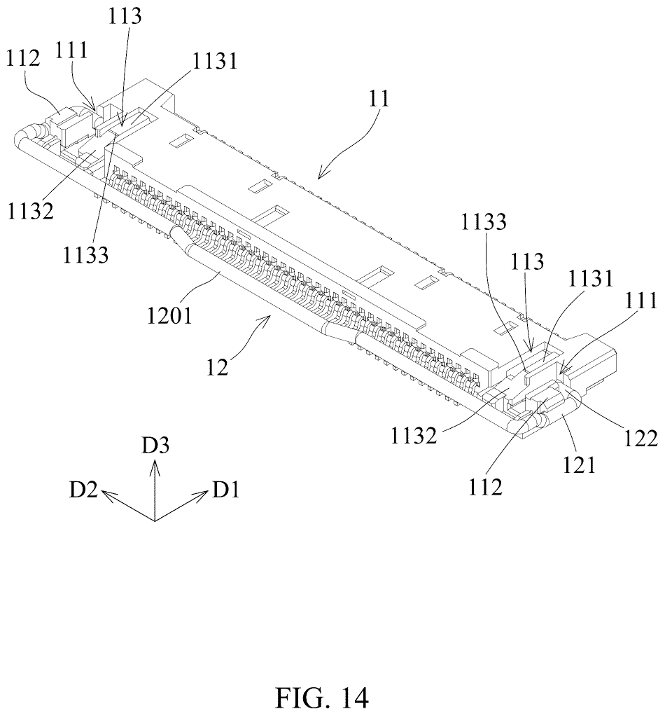

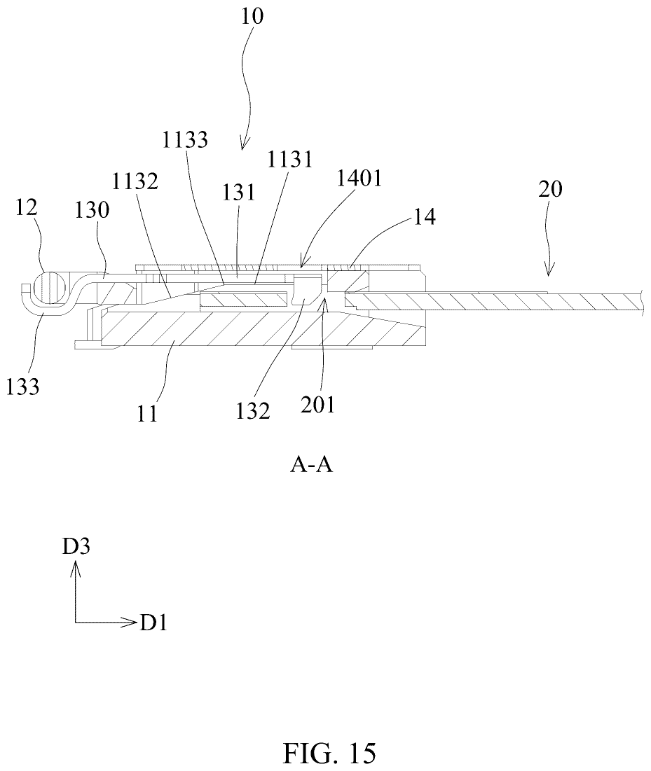

FIG. 14 is a perspective view of the easy-lock connector, in which the locking members and the conductive shell are not shown. FIG. 15 is a cross-sectional view taken along the line AA in FIG. 10. How the locking arm 131 is biased from the locking position to the unlocking position will be explained in detail with reference to FIGS. 14 and 15.

As shown in FIG. 14, the mounting portion 113 is formed with a horizontal surface 1131 and an inclined surface 1132 which is inclined with respect to the horizontal surface 1131. The inclined surface 1132 is located behind the horizontal surface 1131 in the first direction D1. The horizontal surface 1131 and the inclined surface 1132 are positioned generally below the locking arm 131 of the locking member 13. The boundary line 1133 (or the boundary zone with a certain width) between the horizontal surface 1131 and the inclined surface 1132 serves as a fulcrum portion. The stopper protrusion 112 is formed above the rocker arm 121 of the U-shaped push bar 12 to prevent the rocker arm 121 from being swung upwardly.

As shown in FIG. 15, there is a space below the body portion 130 and the actuated portion 133 of the locking member 13, and the space allows movement of the body portion 130 and the actuated portion 133. When the actuated portion 133 of the locking member 13 is moved downwardly by pressing the bar body 120 of the U-shaped push bar 12, the locking arm 131 is pivotally supported by the fulcrum portion (i.e., the boundary line 1133), so that the distal end of the locking arm 131 is moved upwardly. At that time, the lock arm 131 acts similarly to a seesaw. Thereby, the locking arm 131 is biased from the locking position to the unlocking position, so as to release the lock on the flat connection object 20.

As can be clearly seen in FIG. 15, the front edge of the latch tab 132 is configured to be inclined toward the insertion direction of the flat connection object 20. When the flat connection object 20 is inserted into the fitting opening 110, the insertion end of the flat connection object 20 is abutted against the front edge of the latch tab 132, and further movement of the flat connection object 20 toward the insertion direction causes the latch tab 132 to be biased upwardly, so that the locking arm is biased away from the locking position. Therefore, the flat connection object 20 can be automatically locked simply by inserting the flat connection object 20 into the fitting opening 110.

### The Second Embodiment

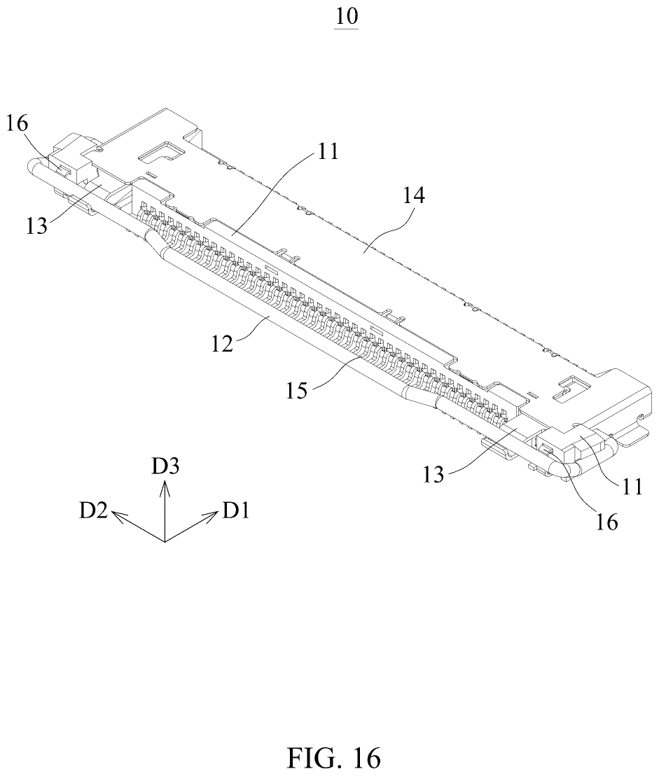

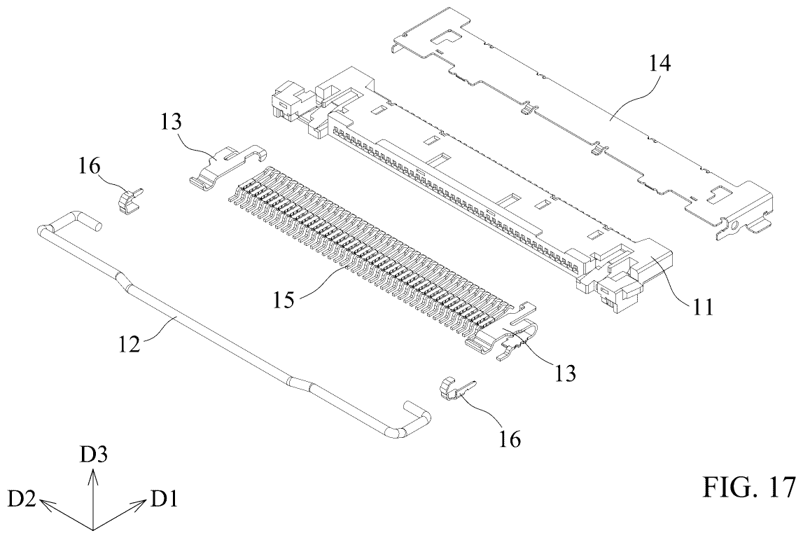

FIG. 16 is a perspective view of the easy-lock connector for a flat connection object according to the second embodiment of the present invention. FIG. 17 is an exploded perspective view of the easy-lock connector for a flat connection object according to the second embodiment of the present invention. The easy-lock connector for a flat connection object is entirely denoted by the reference numeral 10. The constituent components of the easy-lock connector 10 according to the second embodiment of the present invention is schematically described by referring to FIG. 16 and FIG. 17. The easy-lock connector 10 according to the second embodiment comprises an insulating housing 11, a U-shaped push bar 12, two locking members 13, a conductive shell 14, a plurality of contacts 15 and two tactile feedback members 16.

The difference between the second embodiment and the first embodiment lies in that the easy-lock connector of the second embodiment further includes the tactile feedback members 16. Therefore, description of the configuration of the second embodiment same or similar to the first embodiment will be omitted.

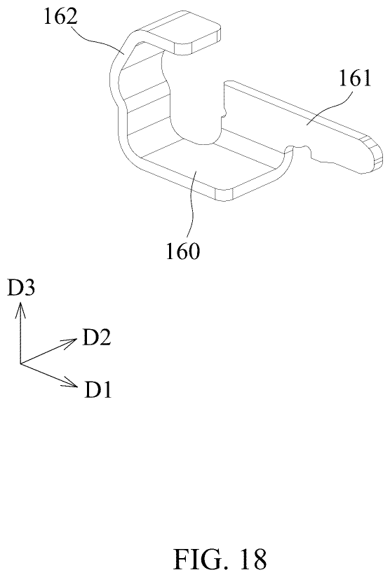

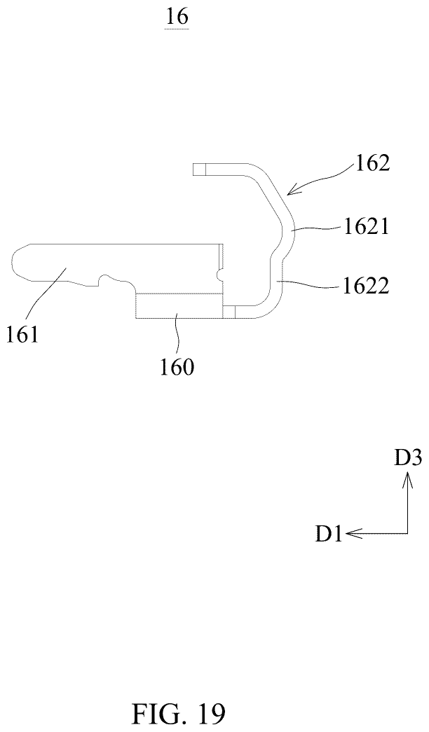

FIG. 18 is a perspective view of the tactile feedback member. FIG. 19 is a side view of the tactile feedback member. The structure of the tactile feedback member 16 is described with reference to FIG. 18 and FIG. 19. The tactile feedback member 16 is disposed between the pivot portion of the U-shaped push bar 12 and the bar body of the U-shaped push bar 12 in the first direction D1 so as to interact with the U-shaped push bar 12.

The tactile feedback member 16 is made by punching and bending a metal plate. The tactile feedback member 16 includes a body portion 160, a held portion 161 and a tactile feedback elastic piece 162. The held portion 161 formed with the barb structure is inserted into a corresponding holding hole formed in the insulating housing 11 in an interference fit manner. In this way, the tactile feedback member 16 is attached to the insulating housing 11. The tactile feedback elastic piece 162 is generally C-shaped or U-shaped and has a convexly curved section 1621 protruded in the first direction D1 backwardly and a straight section 1622 extending generally in the third direction D3 and located below the convexly curved section 1621. In the second embodiment, the upper end of the tactile feedback elastic piece 162 is a movable end, and the lower end of the tactile feedback elastic piece 162 is a fixed end. When the U-shaped push bar 12 is pressed and moved, the convexly curved section 1621 would interfere with the bar body of the U-shaped push bar 12 to provide additional resistance.

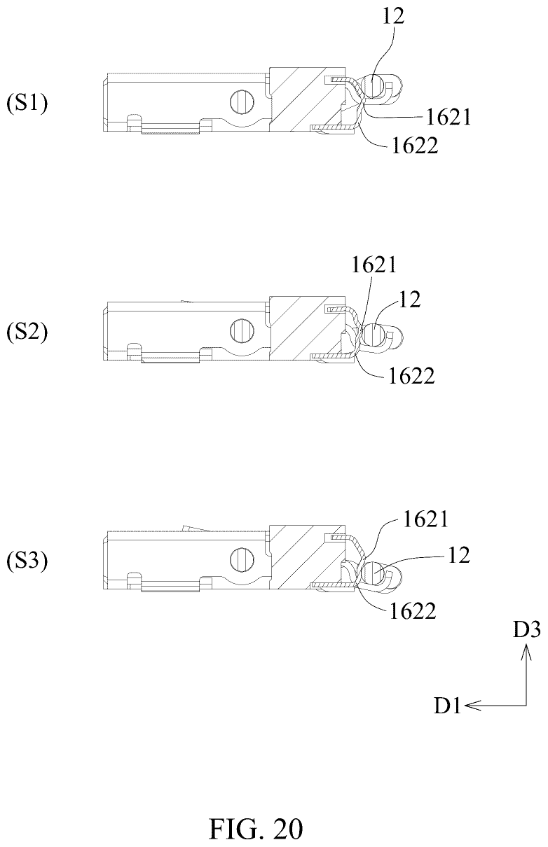

FIG. 20 is a view schematically showing the process of biasing the locking arm from the locking position to the unlocking position by pressing the U-shaped push bar. This process includes a first state S1, a second state S2 and a third state S3 in sequence. In the first state S1, the bar body of the U-shaped push bar 12 is located in an upper position corresponding to the locking position. In the third state S3, the bar body of the U-shaped push bar 12 is located in a lower position corresponding to the unlocking position. In the second state S2, the bar body of the U-shaped push bar 12 is located at an intermediate position between the upper position and the lower position.

When the bar body of the U-shaped push bar 12 is located in the upper position or the lower position, the tactile feedback elastic piece 162 would not substantially interfere with the bar body of the U-shaped push bar 12. At that time, the tactile feedback elastic piece 162 does not provide additional resistance. Alternatively, the tactile feedback elastic piece 162 may slightly interfere with the bar body of the U-shaped push bar 12, resulting in small additional resistance provided by the tactile feedback elastic piece 162. When the bar body of the U-shaped push bar 12 is located in the middle position, the tactile feedback elastic piece 162 provides additional resistance due to the interference between the convexly curved section 1621 and the bar body of the U-shaped push bar 12.

Therefore, during a process of pressing the U-shaped push bar, the resistance caused by the tactile feedback elastic piece 162 changes with the position of the bar body of the U-shaped push bar 12. Change in resistance is perceptible by the user and can be used to indicate that the bar body of the U-shaped push bar 12 has been pressed to the lower position corresponding to the unlocking position. As to the pattern of change in resistance, in this embodiment, the tactile feedback elastic piece 162 is configured such that when the bar body of the U-shaped push bar member 12 is moved downwardly and gets over the convexly curved section 1621 of the tactile feedback elastic piece 162, the resistance caused by the tactile feedback elastic piece 162 gradually increases and then suddenly decreases. Due to the step between the convexly curved section 1621 and the straight section 1622, once the bar body of the U-shaped push bar 12 gets over the convexly curved section 1621 of the tactile feedback elastic piece 162, the straight section 1622 of the tactile feedback elastic piece 162 springs back and hits the bar body of the U-shaped push bar 12 so as to produce a clicking sound or clicking feel as feedback.

The fact that whether the bar body of the U-shaped push bar 12 has been moved to the lower position corresponding to the unlocking position can be determined by the user based on the change in the resistance transmitted to the user's finger, the clicking sound or the clicking feel.

The pattern of the change in resistance and production of the clicking sound or clicking feel are directly affected by the shape or contour of the tactile feedback elastic piece 162. The desired pattern of the change in resistance can be obtained by modifying the shape or contour of the tactile feedback elastic piece 162. In a variant of this embodiment, the tactile feedback elastic piece 162 is configured such that when the bar body of the U-shaped push bar 12 is moved downwardly and gets over the convexly curved portion 1621 of the tactile feedback elastic piece 162, the resistance caused by the tactile feedback elastic piece 162 suddenly increases and then suddenly decreases. The clicking sound or clicking feel can be changed by modifying the shape or contour of the tactile feedback elastic piece 162. This is apparent to those skilled in the art. Therefore, those skilled in the art can design the shape or contour of the tactile feedback elastic piece according to the desired pattern of the change in resistance or according to the desired clicking sound or clicking feel.

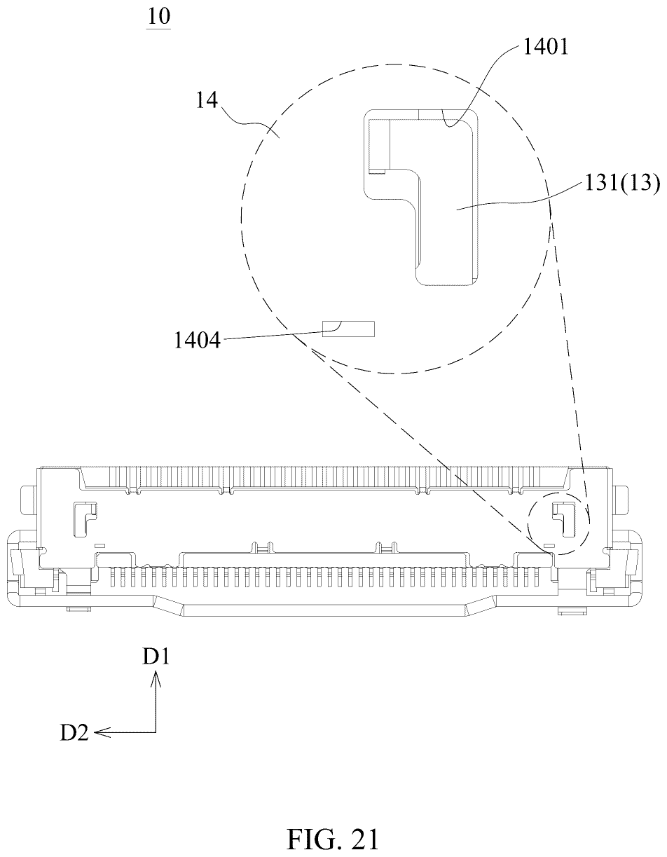

Another difference between the second embodiment and the first embodiment lies in that the conductive shell 14 of the easy-lock connector 10 of the second embodiment further has a second observation window 1404. FIG. 21 is a top view of the easy-lock connector according to the second embodiment of the present invention. As shown in FIG. 21, the second observation window 1404 is positioned to allow the insertion end of a flat connection object which has been inserted into the easy-lock connector 10 to be seen or visually detected. If the insertion end of the flat connection object is observed from the second observation window 1404, it can be determined that the flat connection object has been properly inserted into the easy-lock connector (that is, the flat connection object has been locked).

### The Third Embodiment

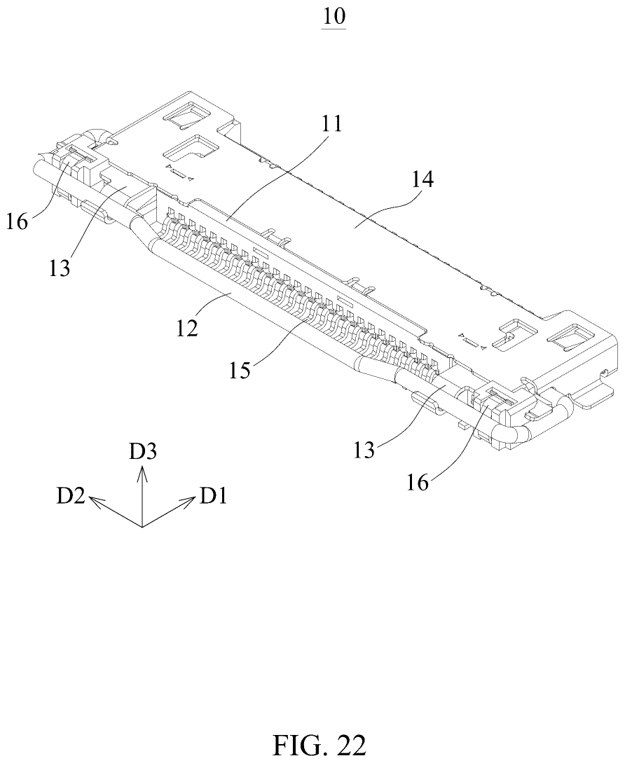

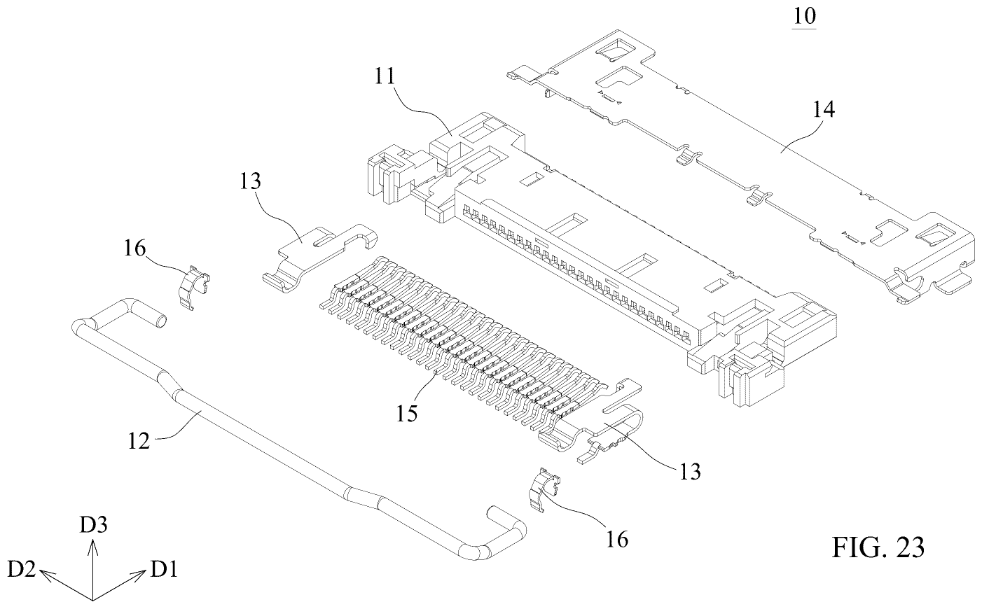

FIG. 22 is a perspective view of the easy-lock connector for a flat connection object according to the third embodiment of the present invention. FIG. 23 is an exploded perspective view of the easy-lock connector for a flat connection object according to the third embodiment of the present invention. The easy-lock connector for a flat connection object is entirely denoted by the reference numeral 10. The constituent components of the easy-lock connector 10 according to the third embodiment of the present invention is schematically described by referring to FIG. 22 and FIG. 23. The easy-lock connector 10 according to the third embodiment comprises an insulating housing 11, a U-shaped push bar 12, two locking members 13, a conductive shell 14, a plurality of contacts 15 and two tactile feedback elastic members 16.

The difference of the third embodiment from the first and second embodiments lies in the configuration of the insulating housing, the conductive shell and the tactile feedback member. Therefore, description of the configurations in the third embodiment same or similar to those in the first or second embodiment will be omitted.

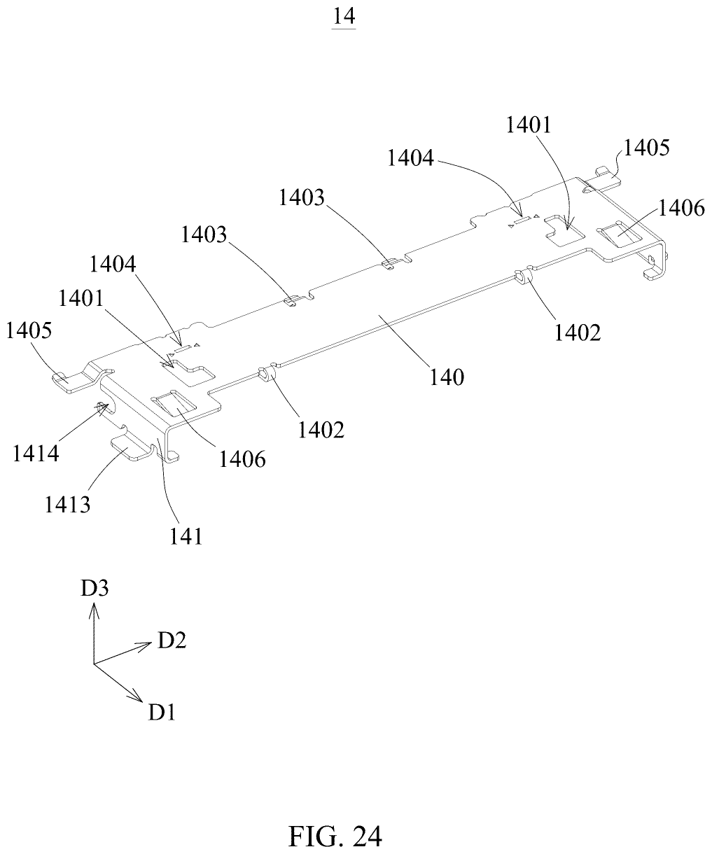

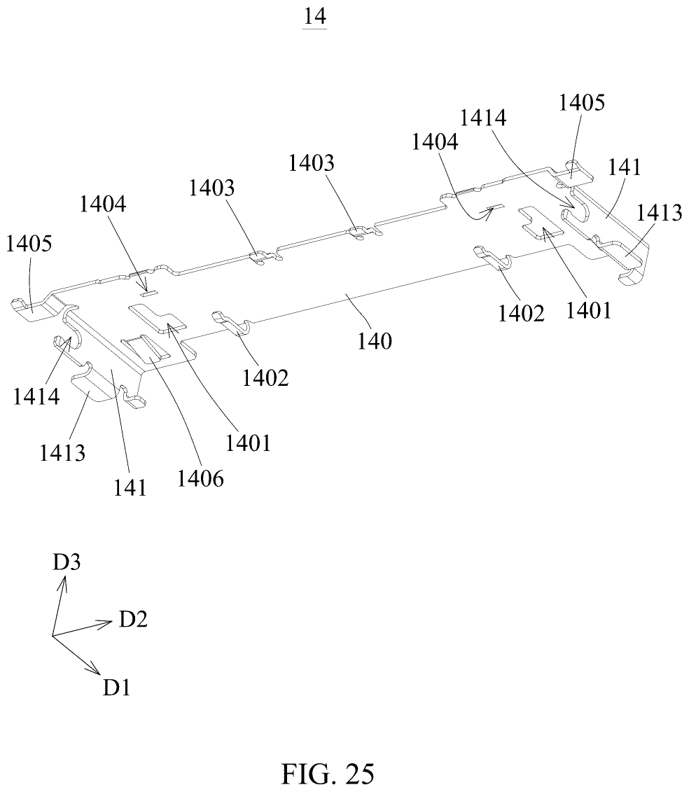

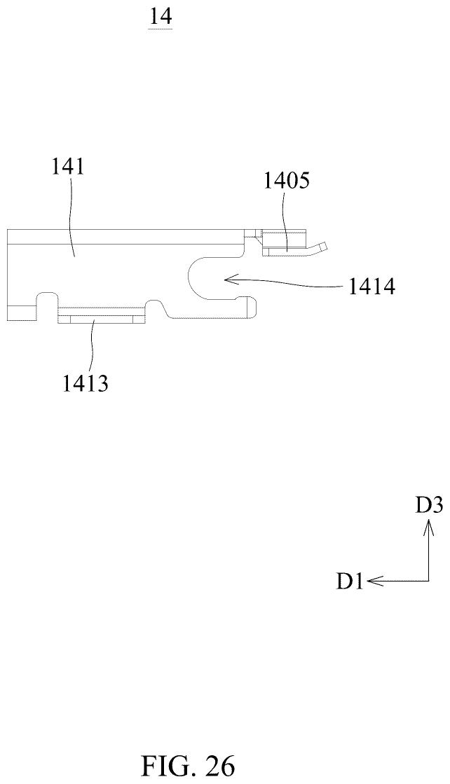

FIG. 24 is a perspective view of the conductive shell 14. FIG. 25 is another perspective view of the conductive shell 14. FIG. 26 is a side view of the conductive shell 14. The structure of the conductive shell 14 of the third embodiment is described with reference to FIGS. 24 to 26.

The conductive shell 14 is formed by punching and bending a metal plate. The conductive shell 14 is attached to the insulating housing 11 to cover the upper surface and lateral surfaces of the insulating housing 11. The conductive shell 14 includes a shell body 140 and two lateral wall portions 141 respectively formed at two ends of the shell body 140 in the second direction D2. The shell body 140 is formed with a first observation window 1401 at a position corresponding to the locking arm 131 and a second observation window 1404 at a position corresponding to the insertion end of the flat connection object. A plurality of elastic pieces 1402 are formed on the front edge of the shell body 140. These elastic pieces 1402 are bent and extended into the fitting opening 110 of the insulating housing 11 so as to be in contact with the conductive metal foil formed on the flat connection object 20 inserted into the easy-lock connector 10. The shell body 140 is formed with a plurality of engaging tabs 1403 on the rear edge. The engaging tabs 1403 are inserted into engaging grooves or engaging holes formed in the insulating housing 11.

Instead of the stopper protrusions 112 of the insulating housing 11 of the first embodiment, the housing body 140 of the conductive housing 14 of the third embodiment is formed with two stopper tabs 1405 extending substantially horizontally. The stopper tabs 1405 are positioned above the rocker arms 121 of the U-shaped push bar 12 to prevent the rocker arm 121 of the U-shaped push bar 12 from being swung upwardly.

The lateral wall portion 141 is formed with a second restricting notch 1414 and a soldered portion 1413. The second restricting notch 1414 is opened to the first direction D1 backwardly. When the second restricting notch 1414 is engaged with the pivot portion 122 of the U-shaped push bar 12, the second restricting notch 1414 prevents the pivot portion 122 of the U-shaped push bar 12 from being moved in the third direction D3.

The soldered portion 1413 is positioned on a plane perpendicular to the third direction D3. The soldered portion 1413 can be soldered to the soldering pad of the circuit board (not shown) by surface mounting technology (SMT), thereby mounting the easy-lock connector to the circuit board and connecting the conductive shell 14 to the ground.

The shell body 140 of the conductive shell 14 of the third embodiment is further formed with two detent portions 1406 which are biased downwardly. The conductive shell 14 is configured to be attached to the insulating housing 11 in the first direction D1, and the detent portion 1406 functions to prevent the conductive shell 14 from being removed from the insulating housing 11 in the first direction D1.

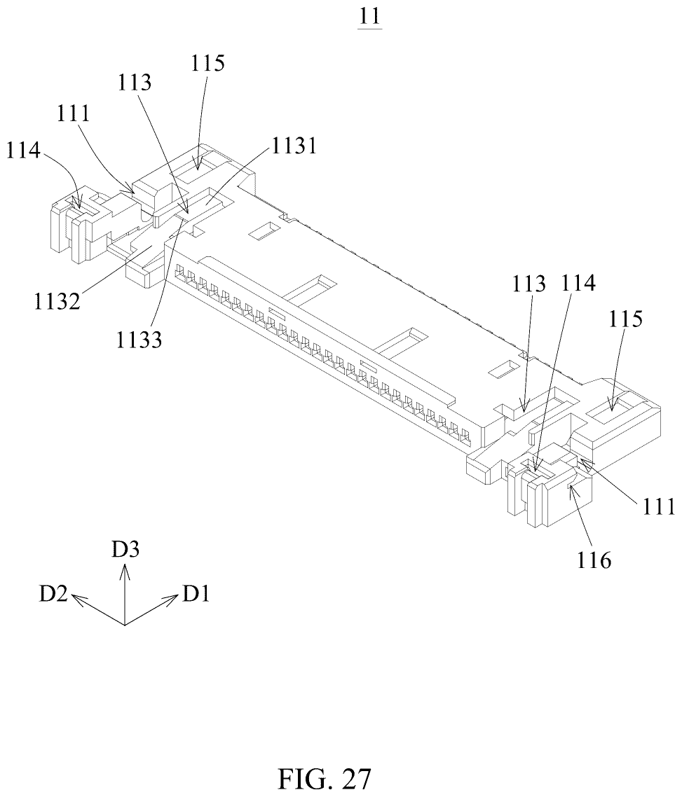

FIG. 27 is a perspective view of the insulating housing 11. The structure of the insulating housing 11 of the third embodiment is described with reference to FIG. 27.

In terms of the fitting opening 110, the first restricting notch 111 and the mounting portion 113, the insulating housing 11 of the third embodiment is the same as the insulating housing 11 of the first or second embodiment. The insulating housing 11 of the third embodiment has a holding hole 114 extending in the third direction D3 near the rear end for holding the tactile feedback member. The insulating housing 11 of the third embodiment has a stepped recess portion 115 corresponding to the detent portion 1406. By means of engagement of the detent portion 1406 with the stepped recess portion 115, the conductive shell 14 is prevented from being removed from the insulating housing 11 in the first direction D1.

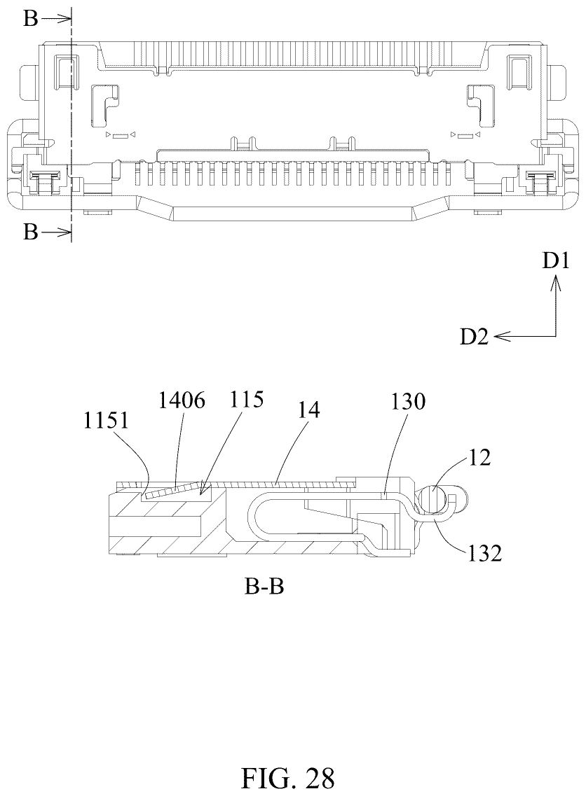

FIG. 28 is a cross-sectional view of the easy-lock connector 10 according to the third embodiment taken along the line BB. As shown in FIG. 28, the stepped recess portion 115 has a stop surface 1151 formed by a step portion. The detent portion 1406 is abutted against the stop surface 1151 so that the conductive shell 14 is unable to be removed from the insulating housing 11 in the direction toward the left hand side in the drawing sheet. The height of a step portion forming the stop surface 1151 has to be appropriately decided to prevent the step portion from colliding with the root of the detent portion 1406 when the conductive shell 14 is being attached to the insulating housing. If the step portion collides with the root of the detent portion 1406, the detent portion 1406 may be deformed.

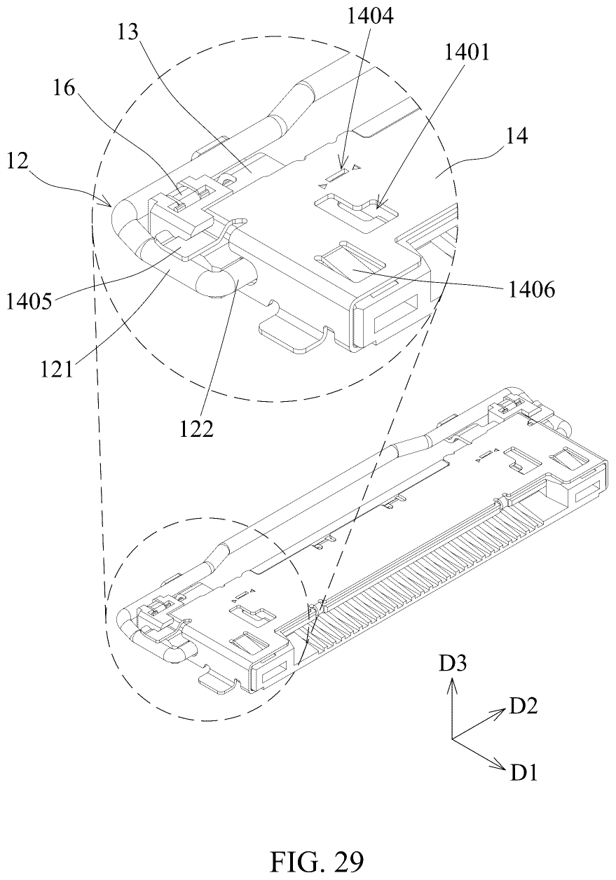

In addition, the insulating housing 11 of the third embodiment has a groove 116. The stopper tab 1405 is to be partially embedded in the groove 116 in the first direction D1. When the conductive shell 14 is attached to the insulating housing 11 in the first direction, the stopper tab 1405 is partially embedded in the groove 116, so that the movement of the stopper tab 1405 in the third direction D3 is prevented by the groove walls of the groove 116. By means of this configuration, the rigidity of the structure for preventing the rocker arm 121 of the U-shaped push bar 12 from being swung upwardly is enhanced. FIG. 29 is a partially enlarged perspective view of the easy-lock connector 10 according to the third embodiment. As shown in FIG. 29, the stopper tab 1405 is positioned above the rocker arm 121 of the U-shaped push bar 12, and the stopper tab 1405 is partially embedded in the insulating housing 11. By means of this configuration, the rocker arm 121 of the U-shaped push bar 12 can be reliably prevented from being swung upwardly.

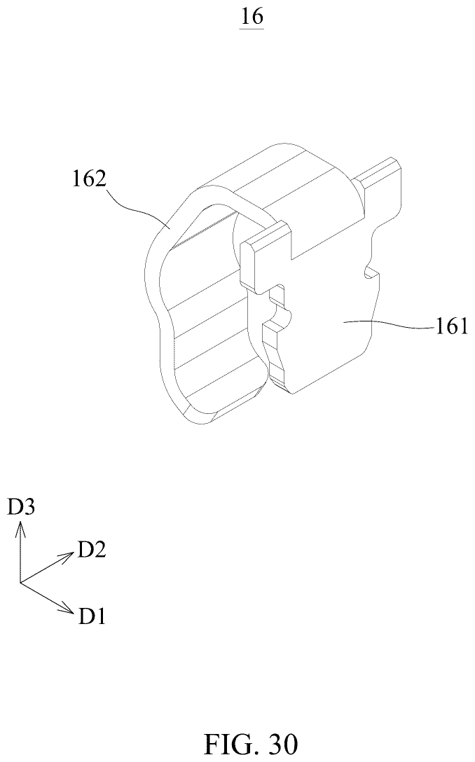

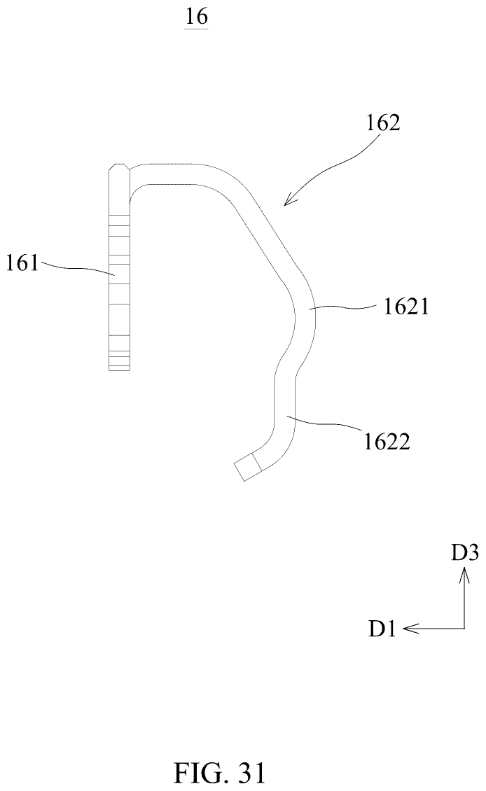

FIG. 30 is a perspective view of the tactile feedback member of the easy-lock connector according to the third embodiment. FIG. 31 is a side view of the tactile feedback member of the easy-lock connector according to the third embodiment. The structure of the tactile feedback member 16 of the third embodiment is described with reference to FIG. 30 and FIG. 31. The tactile feedback member 16 is disposed between the pivot portion of the U-shaped push bar 12 and the bar body of the U-shaped push bar 12 in the first direction so as to interact with the U-shaped push bar 12.

The tactile feedback member 16 is made by punching and bending a metal plate. The tactile feedback member 16 includes a held portion 161 and a tactile feedback elastic piece 162. As compared with the tactile feedback member of the easy-lock connector according to the second embodiment, the tactile feedback member of the easy-lock connector according to the third embodiment has a simpler structure and is easier to manufacture. The held portion 161 formed with a barb structure is inserted into the holding hole 114 formed in the insulating housing 11 in the third direction D3 in an interference fit manner. In this way, the tactile feedback member 16 is attached to the insulating housing 11. The tactile feedback elastic piece 162 is generally C-shaped or U-shaped and has a convexly curved section 1621 protruded in the first direction D1 backwardly and a straight section 1622 extending generally in the third direction D3 and located below the convexly curved section 1621. In the third embodiment, the upper end of the tactile feedback elastic piece 162 is a fixed end, and the lower end of the tactile feedback elastic piece 162 is a movable end. When the U-shaped push bar 12 is pressed and moved, the convexly curved section 1621 interferes with the bar body of the U-shaped push bar 12 so as to provide additional resistance.

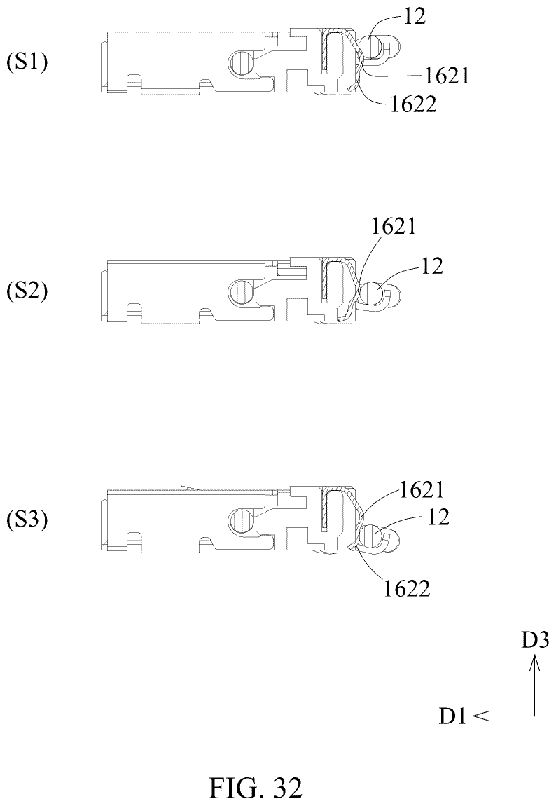

FIG. 32 is a view schematically showing the process of biasing the locking arm from the locking position to the unlocking position by pressing the U-shaped push bar. This process includes a first state S1, a second state S2 and a third state S3 in sequence. In the first state S1, the bar body of the U-shaped push bar 12 is located in an upper position corresponding to the locking position. In the third state S3, the bar body of the U-shaped push bar 12 is located in a lower position corresponding to the unlocking position. In the second state S2, the bar body of the U-shaped push bar 12 is located in an intermediate position between the upper position and the lower position. Due to the fact that the upper end of the tactile feedback elastic piece 162 of the third embodiment is the fixed end and that the lower end of the tactile feedback elastic piece 162 of the third embodiment is a free end, the easy-lock connector according to the third embodiment can prevent the tactile feedback elastic piece 162 from the risk of pin collapse when the U-shaped push bar 12 is pressed downwardly.

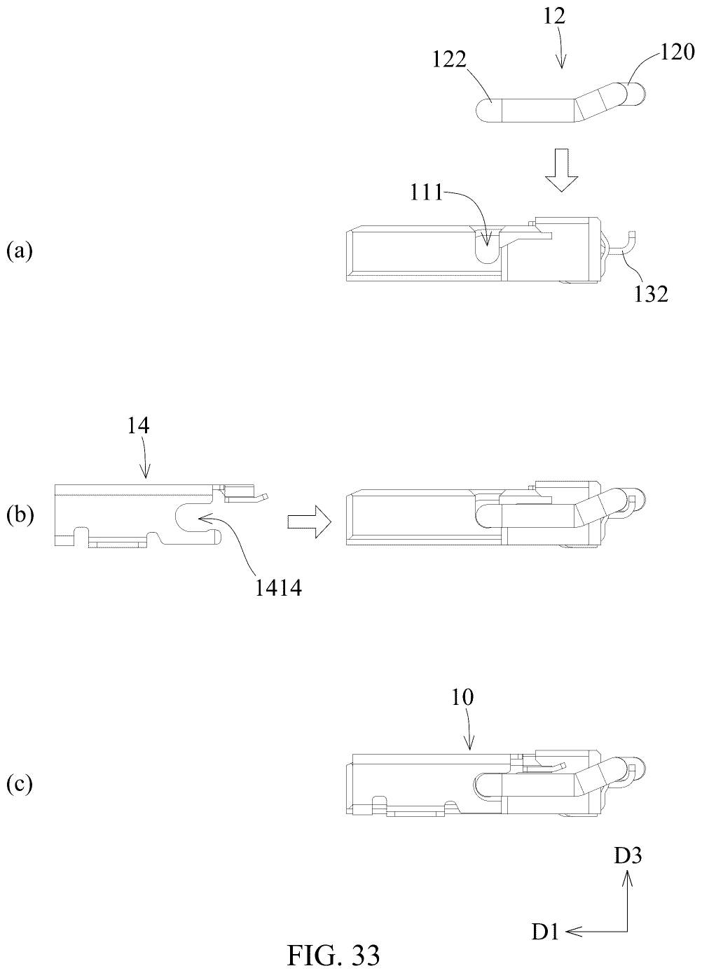

FIG. 33 schematically illustrates the process of assembling the easy-lock connector according to the third embodiment. The method of assembling the easy-lock connector according to the third embodiment is described with reference to FIG. 33.

As shown in FIG. 33, the process of assembling the easy-lock connector according to the third embodiment includes: the phase (a) in which the pivot portion 122 of the U-shaped push bar 12 is placed in the first restricting notch 111 of the insulating housing 11 in the third direction D3; the phase (b) in which the conductive shell 14 is attached to the insulating housing 11 in the first direction D1, so that the second restricting notch 1414 of the conductive shell 14 is engaged with the pivot portion 122 of the U-shaped push bar 12; and the phase (c) in which assembly of the easy-lock connector is finished. Prior to the phase (a), the locking members 13, the contacts 15 and the tactile feedback members 16 are attached to the insulating housing 11. If necessary, the locking members 13, the contacts 15 and the tactile feedback members 16 may be attached to the insulating housing 11 after the phase (b).

Therefore, according to the present invention, the method of assembling the easy-lock connector according to the third embodiment at least includes the following steps of: placing the two pivot portions of the U-shaped push bar in the two first restricting notches of the insulating housing in the third direction, respectively; and attaching the conductive shell to the insulating housing in the first direction, so that the two second restricting notches of the conductive shell are engaged with the two pivot portions of the U-shaped push bar.

As can be seen in FIG. 27, the first restricting notch 111 of the insulating housing 11 is opened to the third direction D3 upwardly. When the pivot portion 122 of the U-shaped push bar 12 is positioned in the first restricting notch 111, the first restricting notch 111 can prevent the pivot portion 122 from being moved in the first direction D1. As can be seen in FIG. 26, the second restricting notch 1414 of the conductive shell 14 is opened to the first direction D1 backwardly. When the second restricting notch 1414 is engaged with the pivot portion 122 of the U-shaped push bar 12, the second restricting notch 1414 can prevent the pivot portion 122 from being moved in the third direction D3. The first restricting notch 111 cooperates with the second restricting notch 1414 so as to pivotably retain the pivot portion 122 of the U-shaped push bar 12.

One advantage of the easy-lock connector according to the third embodiment lies in that automated assembly of the easy-lock connector can be easily implemented. This is because during installation of the U-shaped push bar 12, there is no need to deform the U-shaped push bar 12 in such a way that the distance between the two pivot portions 122 is enlarged.

The easy-lock connector according to the present invention indeed has the advantages of low profile and good operability. In addition, the easy-lock connector according to the present invention is particularly suitable for use in a compact or thin electronic machine. Additionally, the easy-lock connector according to the present invention is also suitable for automated assembly of a flat connection object and an easy-lock connector.

While this invention has been described in reference to a preferred embodiment, it should be understood that numerous changes and modifications could be made within the spirit and scope of the inventive concepts described. Accordingly, it is intended that the invention not be limited to the disclosed embodiment, but that it have the full scope permitted by the language of the following claims.

What is claimed is:

1. An easy-lock connector for a flat connection object, the flat connection object comprising a pair of notches and a plurality of electrode portions, the plurality of electrode portions being formed on an insertion end of the flat connection object, the pair of notches being respectively formed on two opposite lateral edges of the flat connection object and adjacent to the insertion end, the easy-lock connector comprising:
an insulating housing including a fitting opening for insertion of the flat connection object in a first direction;
a plurality of contacts held by the insulating housing and arranged in a second direction perpendicular to the first direction, each contact including a contact portion extending into the fitting opening and being to be in contact with one of the plurality of electrode portions and a connection terminal portion opposite to the contact portion and extending out of the insulating housing;
two locking members, each locking member comprising a locking arm and an actuated portion, the locking arm being normally and elastically biased to a locking position, the locking arm being formed on a distant end with a latch tab so that when the flat connection object is inserted into the fitting opening, the latch tab is engaged with a respective notch of the pair of notches, preventing the flat connection object from being removed from the easy-lock connector; and
a U-shaped push bar, comprising a bar body extending in the second direction and two rocker arms formed on two ends of the bar body respectively and perpendicular to the bar body, the two rocker arms being pivotably arranged on the insulating housing about an axis parallel to the second direction, the bar body being operatively connected with the actuated portion of each locking member, the locking arm being biased away from the locking position by operating the bar body for releasing lock on the flat connection object.

2. The easy-lock connector of claim 1, wherein each locking member comprises a body portion, the locking arm extends from one side of the body portion, the actuated portion is formed on the other side of the body portion, and the body portion is elastically supported in such a way that the locking arm is normally biased to the locking position.

3. The easy-lock connector of claim 2, wherein each locking member comprises a held portion held by the insulating housing and a spring portion, and the held portion and the body portion are connected by the spring portion so that the body portion is elastically supported and floatable with respect to the held portion.

4. The easy-lock connector of claim 2, wherein the insulating housing is formed beneath the locking arm of each locking member with a fulcrum portion, when the actuated portion of each locking member is moved downwardly by pressing the bar body of the U-shaped push bar, the locking arm is pivotably supported by the fulcrum portion so that a distant end of the locking arm is lifted, thereby biasing the locking arm away from the locking position for releasing the lock on the flat connection object.

5. The easy-lock connector of claim 4, wherein the insulating housing is formed beneath the locking arm of each locking member with a horizontal surface and an inclined surface inclined with respect to the horizontal surface, and a boundary line or strip between the horizontal surface and the inclined surface serves as the fulcrum portion.

6. The easy-lock connector of claim 1, further comprising a conductive shell attached to the insulating housing and covering at least a portion of the insulating housing, wherein the conductive shell is formed with a first observation window which is positioned to allow an engagement state of the locking arm with one of the notches of the flat connection object inserted into the fitting opening to be visible or inspected visually.

7. The easy-lock connector of claim 6, wherein the conductive shell is formed with a second observation window which is positioned to allow the insertion end of the flat connection object inserted into the fitting opening to be visible or inspected visually.

8. The easy-lock connector of claim 6, wherein the conductive shell is formed with two stopper tabs respectively positioned above the two rocker arms for preventing the two rocker arms from being swung upwardly.

9. The easy-lock connector of claim 1, wherein the insulating housing is formed with two stopper protrusions respectively positioned above the two rocker arms for preventing the two rocker arms from being swung upwardly.

10. An easy-lock connector for a flat connection object, the flat connection object comprising a pair of notches and a plurality of electrode portions, the plurality of electrode portions being formed on an insertion end of the flat connection object, the pair of notches being respectively formed on two opposite lateral edges of the flat connection object and adjacent to the insertion end, the easy-lock connector comprising:
an insulating housing including a fitting opening for insertion of the flat connection object in a first direction;
a plurality of contacts held by the insulating housing and arranged in a second direction perpendicular to the first direction, each contact including a contact portion extending into the fitting opening and being to be in contact with one of the plurality of electrode portions and a connection terminal portion opposite to the contact portion and extending out of the insulating housing;
two locking members, each locking member comprising a locking arm and an actuated portion, the locking arm being normally and elastically biased to a locking position, the locking arm being formed on a distant end with a latch tab so that when the flat connection object is inserted into the fitting opening, the latch tab is engaged with a respective notch of the pair of notches, preventing the flat connection object from being removed from the easy-lock connector;
a U-shaped push bar, comprising a bar body extending in the second direction and two rocker arms formed on two ends of the bar body respectively and perpendicular to the bar body, the two rocker arms being pivotably arranged on the insulating housing about an axis parallel to the second direction, the bar body being operatively connected with the actuated portion of each locking member, the locking arm being biased away from the locking position by operating the bar body for releasing lock on the flat connection object; and
a tactile feedback elastic piece, arranged to interfere with the bar body of the U-shaped push bar during a process of pushing the bar body downwardly, so as to generate a resistance force as a function of a position of the bard body or generate a feedback clicking sound or a feedback clicking feel.

11. The easy-lock connector of claim 10, wherein each locking member comprises a body portion, the locking arm extends from one side of the body portion, the actuated portion is formed on the other side of the body portion, and the body portion is elastically supported in such a way that the locking arm is normally biased to the locking position.

12. The easy-lock connector of claim 11, wherein the insulating housing is formed beneath the locking arm of each locking member with a fulcrum portion, when the actuated portion of each locking member is moved downwardly by pressing the bar body of the U-shaped push bar, the locking arm is pivotably supported by the fulcrum portion so that a distant end of the locking arm is lifted, thereby biasing the locking arm away from the locking position for releasing the lock on the flat connection object.

13. The easy-lock connector of claim 10, wherein the tactile feedback elastic piece is configured to be C-shaped.

14. The easy-lock connector of claim 10, wherein the tactile feedback elastic piece comprises a convexly curved section and a straight section positioned under the convexly curved section, the convexly curved section is protruded in the first direction backwardly, the straight section is substantially in parallel to a third direction perpendicular to the first direction and the second direction.

15. The easy-lock connector of claim 10, further comprising a conductive shell attached to the insulating housing and covering at least a portion of the insulating housing, wherein the conductive shell is formed with a first observation window which is positioned to allow an engagement state of the locking arm with one of the notches of the flat connection object inserted into the fitting opening to be visible or inspected visually.

16. The easy-lock connector of claim 15, wherein the conductive shell is formed with a second observation window which is positioned to allow the insertion end of the flat connection object inserted into the fitting opening to be visible or inspected visually.

17. The easy-lock connector of claim 15, wherein the conductive shell is formed with two stopper tabs respectively positioned above the two rocker arms for preventing the two rocker arms from being swung upwardly.

18. A method for assembling an easy-lock connector for a flat connection object, the flat connection object comprising a pair of notches and a plurality of electrode portions, the plurality of electrode portions being formed on an insertion end of the flat connection object, the pair of notches being respectively formed on two opposite lateral edges of the flat connection object and adjacent to the insertion end, the easy-lock connector comprising:
an insulating housing including a fitting opening for insertion of the flat connection object in a first direction;
a plurality of contacts held by the insulating housing and arranged in a second direction perpendicular to the first direction, each contact including a contact portion extending into the fitting opening and being to be in contact with one of the plurality of electrode portions and a connection terminal portion opposite to the contact portion and extending out of the insulating housing;
two locking members, each locking member comprising a locking arm and an actuated portion, the locking arm being normally and elastically biased to a locking position, the locking arm being formed on a distant end with a latch tab so that when the flat connection object is inserted into the fitting opening, the latch tab is engaged with a respective notch of the pair of notches, preventing the flat connection object from being removed from the easy-lock connector;
a U-shaped push bar, comprising a bar body extending in the second direction and two rocker arms formed on two ends of the bar body respectively and perpendicular to the bar body, the two rocker arms being pivotably arranged on the insulating housing about an axis parallel to the second direction, the bar body being operatively connected with the actuated portion of each locking member, the locking arm being biased away from the locking position by operating the bar body for releasing lock on the flat connection object; and
a conductive shell attached to the insulating housing and covering at least a portion of the insulating housing, the conductive shell comprising a shell body and two lateral wall portions respectively formed on two ends, in the second direction, of the shell body,
wherein the U-shaped push bar includes two pivot portions respectively formed on ends of the two rocker arms opposite to the bar body, and the two pivot portion are in parallel to the second direction,
the insulating housing is formed with two first restricting notches for receiving the two pivot portions, the two first restricting notches are opened to a third direction, perpendicular to the first direction and the second direction, upwardly, and the conductive shell is formed with two second restricting notches opened to the first direction backwardly,
the method comprises the steps of:
respectively placing the two pivot portions of the U-shaped push bar into the two first restricting notches of the insulating housing in the third direction; and
attaching the conductive shell to the insulating housing in the first direction so that the two second restricting notches of the conductive shell are respectively fitted to the two pivot portions of the U-shaped push bar.

19. The method of claim 18, wherein the conductive shell is formed with two stopper tabs respectively positioned above the two rocker arms for preventing the two rocker arms from being swung upwardly.

20. The method of claim 18, wherein the two locking members are attached to the insulating housing before the step of respectively placing the two pivot portions of the U-shaped push bar into the two first restricting notches of the insulating housing in the third direction is carried out.
